(19) United States
(12) Patent Application Publication
(10) Pub. No.: US 2015/0114484 A1
(43) Pub. Date: Apr. 30, 2015

(54) Ceramic Balance Valve Structure

(71) Applicant: HAIN YO ENTERPRISES CO., LTD., Chang Hwa County (TW)

(72) Inventor: Chia-Po Chang, Chang Hwa County (TW)

(21) Appl. No.: 14/321,849

(22) Filed: Jul. 2, 2014

(30) Foreign Application Priority Data
Oct. 24, 2013 (TW) 102219842

(51) Int. Cl. F16K 11/22; F16K 27/04; F16K 11/00

(52) U.S. Cl. CPC F16K 11/22; F16K 19/00; F16K 27/041
USPC 137/100

(57) ABSTRACT

A ceramic balance valve structure includes a valve tube and a pressure regulating member each of which is made of ceramic material. The valve tube is formed with a through hole and two annular grooves. The pressure regulating member is slidably mounted in the through hole of the valve tube and is provided with two water guide grooves corresponding to the annular grooves of the valve tube. The pressure regulating member is provided with a balance wall located between the two water guide grooves and has two opposite ends each provided with a connecting hole. Thus, the valve tube and the pressure regulating member have a ceramic surface contact therebetween to facilitate a sliding motion of the pressure regulating member and to prevent the pressure regulating member from being jammed in the valve tube.

### BACKGROUND OF THE INVENTION

1. Field of the Invention

The present invention relates to a balance valve and, more particularly, to a ceramic balance valve structure.

2. Description of the Related Art

A conventional faucet comprises a balance valve to regulate the water temperature. The balance valve includes a fixed valve tube and a sliding member slidably mounted in the valve tube. When in use, the sliding member is pushed by the water pressure differential of cold water and hot water of the faucet and is moved successively in the valve tube to reduce the water flow rate at the high pressure terminal so as to stabilize the water temperature in the faucet. However, both of the valve tube and the sliding member are made of metallic material with a larger sliding resistance so that the sliding member is moved slowly in the valve tube, thereby decreasing the pressure regulating speed. In addition, the surface of each of the valve tube and the sliding member has larger pores, and water dirt is easily deposited on the valve tube and the sliding member, so that the sliding member is not moved in the valve tube smoothly. Further, the valve tube and the sliding member are easily rusted when not in use during a long period time, so that the valve tube and the sliding member are jammed.

### BRIEF SUMMARY OF THE INVENTION

In accordance with the present invention, there is provided a ceramic balance valve structure comprising a valve tube and a pressure regulating member. The valve tube is made of ceramic material. The valve tube has an interior formed with a through hole which extends through the valve tube. The valve tube has a mediate portion provided with two annular grooves connected to the through hole. The pressure regulating member is made of ceramic material. The pressure regulating member is slidably mounted in the through hole of the valve tube. The pressure regulating member is provided with two water guide grooves corresponding to the annular grooves of the valve tube. The pressure regulating member is provided with a balance wall located between the two water guide grooves. The pressure regulating member has two opposite ends each provided with a connecting hole. In practice, the valve tube and the pressure regulating member have a ceramic surface contact therebetween to facilitate a sliding motion of the pressure regulating member relative to the valve tube and to prevent the pressure regulating member from being jammed in the valve tube.

Preferably, the ceramic balance valve structure further comprises a balance valve housing. The balance valve housing includes a left valve casing, a right valve casing juxtaposed to the left valve casing, and a balance valve chamber located and connected between the left valve casing and the right valve casing. The left valve casing has a first end provided with a water inlet port and a second end provided with a water outlet port connected to the water inlet port. The right valve casing has a first end provided with a water inlet port and a second end provided with a water outlet port connected to the water inlet port. The balance valve chamber, the water inlet ports of the left valve casing and the right valve casing, and the water outlet ports of the left valve casing and the right valve casing are connected. The balance valve chamber covers the valve tube so that the pressure regulating member is slidable in the balance valve chamber.

Preferably, the water inlet ports of the balance valve housing are connected to the annular grooves of the valve tube. The water outlet ports of the balance valve housing are connected to the connecting hole of the pressure regulating member.

Preferably, the ceramic balance valve structure further comprises a valve body. The balance valve housing is mounted in the valve body. Each of the water outlet ports of the balance valve housing has a periphery provided with an O-ring to provide a leakproof function between the valve body and the balance valve housing.

Preferably, the valve tube has an outer surface provided with a plurality of O-rings to provide a leakproof function between the left valve casing and the right valve casing.

According to the primary advantage of the present invention, both of the valve tube and the pressure regulating member are made of ceramic material with a smooth contact face so that the pressure regulating member is slidable smoothly in the valve tube.

According to another advantage of the present invention, the surface of each of the valve tube and the pressure regulating member has very small pores, so that the valve tube and the pressure regulating member will not be easily deposited with water dirt and will not be rusted when not in use during a long period time, thereby preventing the valve tube and the pressure regulating member from being jammed.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a ceramic balance valve structure in accordance with the preferred embodiment of the present invention.

FIG. 2 is a cross-sectional assembly view of the ceramic balance valve structure as shown in FIG. 1.

FIG. 3 is an exploded perspective view of a ceramic balance valve structure in accordance with another preferred embodiment of the present invention.

FIG. 4 is a cross-sectional assembly view of the ceramic balance valve structure as shown in FIG. 3.

FIG. 5 is a schematic operational view of the ceramic balance valve structure as shown in FIG. 4 in use.

### DETAILED DESCRIPTION OF THE INVENTION

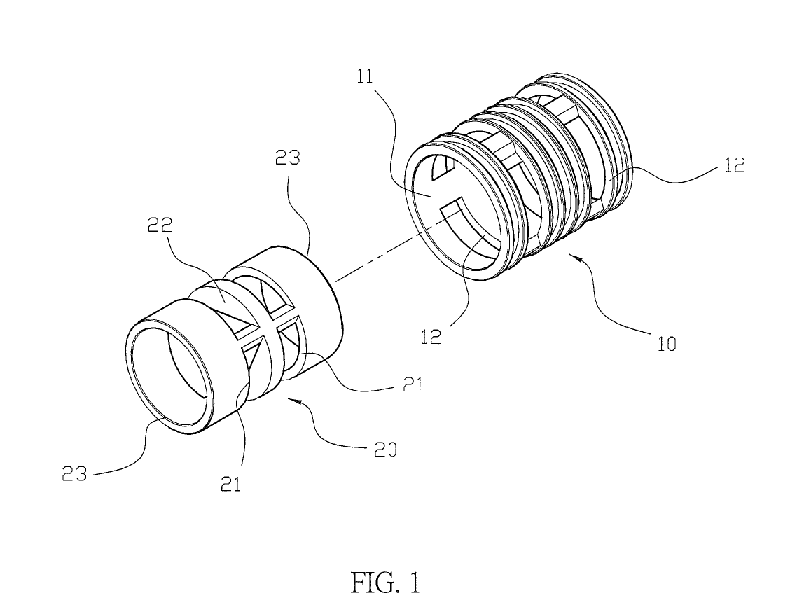

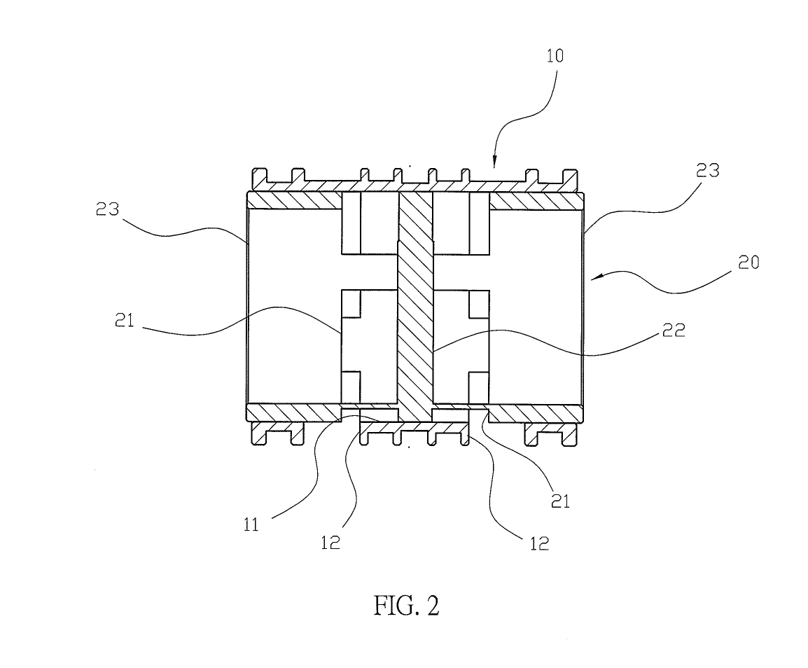

Referring to the drawings and initially to FIGS. 1 and 2, a ceramic balance valve structure in accordance with the preferred embodiment of the present invention comprises a valve tube 10 and a pressure regulating member 20.

The valve tube 10 is made of ceramic material. The valve tube 10 has an interior formed with a through hole 11 which extends through the valve tube 10. The valve tube 10 has a mediate portion provided with two annular grooves 12 connected to the through hole 11.

The pressure regulating member 20 is made of ceramic material. The pressure regulating member 20 is slidably mounted in the through hole 11 of the valve tube 10. The pressure regulating member 20 is provided with two water guide grooves 21 corresponding to the annular grooves 12 of the valve tube 10. The pressure regulating member 20 is provided with a balance wall 22 located between the two water guide grooves 21. The pressure regulating member 20 has two opposite ends each provided with a connecting hole 23.

In practice, the valve tube 10 and the pressure regulating member 20 have a ceramic surface contact therebetween to facilitate a sliding motion of the pressure regulating member 20 relative to the valve tube 10 and to prevent the pressure regulating member 20 from being jammed in the valve tube 10.

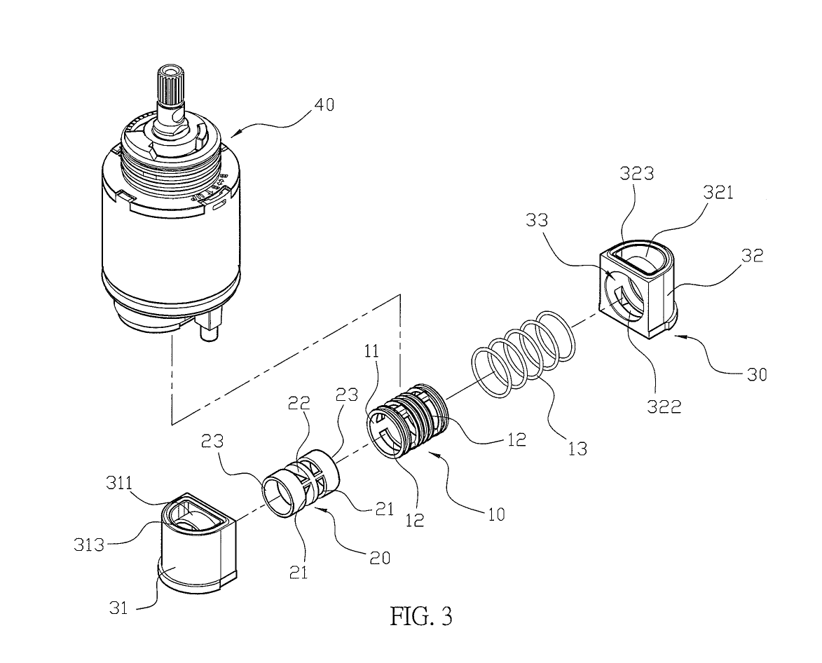

Referring to FIGS. 3-5 with reference to FIGS. 1 and 2, the ceramic balance valve structure is available for a faucet and further comprises a balance valve housing 30 and a valve body 40. The balance valve housing 30 includes a left valve casing 31, a right valve casing 32 juxtaposed to the left valve casing 31, and a balance valve chamber 33 located and connected between the left valve casing 31 and the right valve casing 32. The left valve casing 31 and the right valve casing 32 are symmetrical and are combined together. The left valve casing 31 has a first end provided with a water inlet port 312 and a second end provided with a water outlet port 311 connected to the water inlet port 312. The right valve casing 32 has a first end provided with a water inlet port 322 and a second end provided with a water outlet port 321 connected to the water inlet port 322. The balance valve chamber 33, the water inlet ports 312 and 322 of the left valve casing 31 and the right valve casing 32, and the water outlet ports 311 and 321 of the left valve casing 31 and the right valve casing 32 are connected. The balance valve chamber 33 covers the valve tube 10 so that the pressure regulating member 20 is slidable in the balance valve chamber 33. The water inlet ports 312 and 322 of the balance valve housing 30 are connected to the annular grooves 12 of the valve tube 10. The water outlet ports 311 and 321 of the balance valve housing 30 are connected to the connecting hole 23 of the pressure regulating member 20. The valve tube 10 has an outer surface provided with a plurality of O-rings 13 to provide a leakproof function between the left valve casing 31 and the right valve casing 32. The balance valve housing 30 is mounted in the valve body 40. Each of the water outlet ports 311 and 321 of the balance valve housing 30 has a periphery provided with an O-ring 313 and 323 to provide a leakproof function between the valve body 40 and the balance valve housing 30.

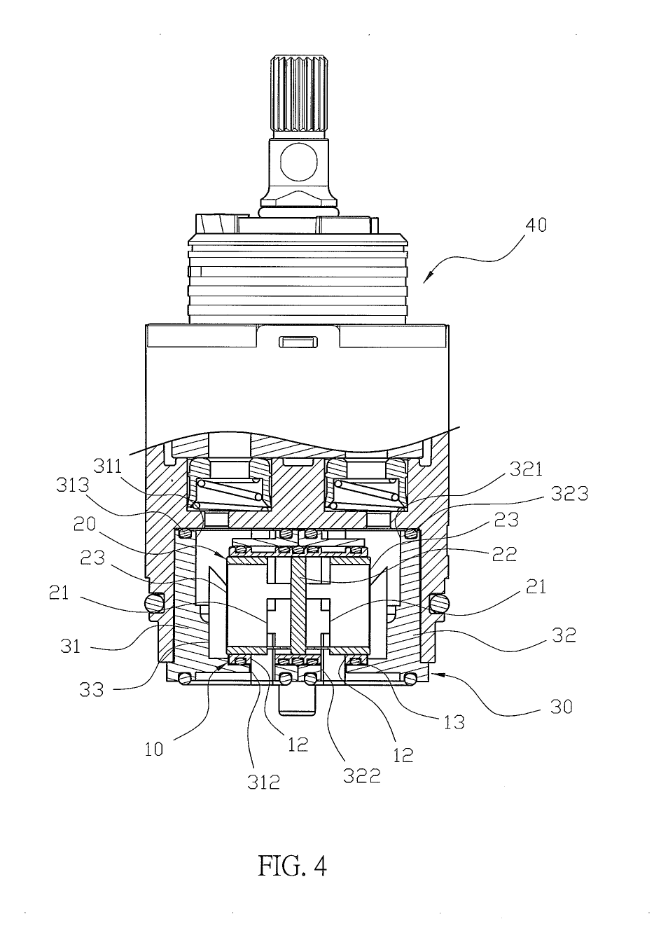

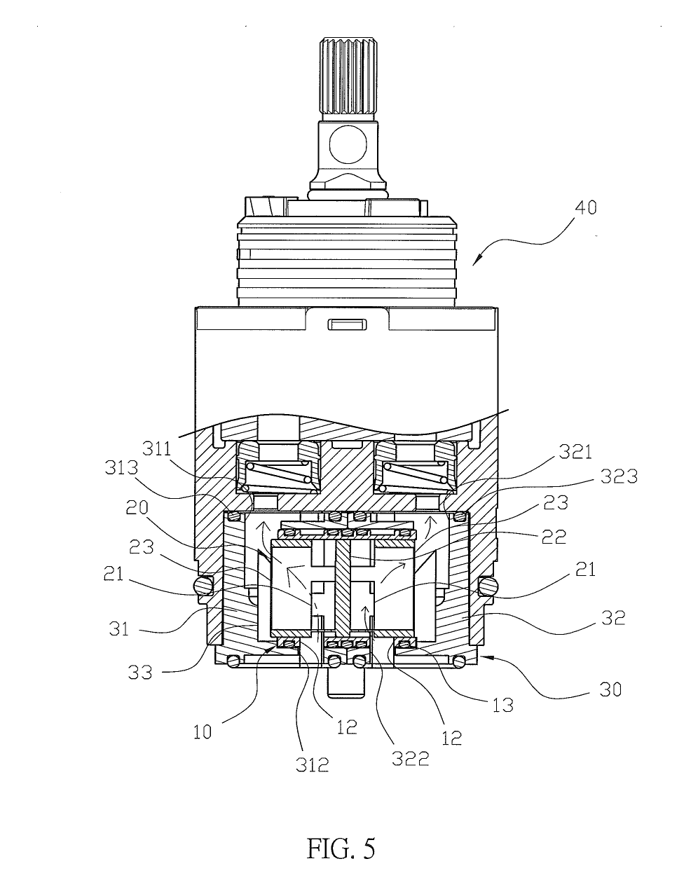

In operation, referring to FIG. 5 with reference to FIGS. 3 and 4, the valve body 40 controls the flow rate of cold water and hot water to mix the cold water and the hot water for use. When supply of the cold water or the hot water is under an abnormal condition, the pressure regulating member 20 functions. In practice, the left valve casing 31 supplies the hot water, and the right valve casing 32 supplies the cold water. When supply of the hot water is reduced or interrupted, the water pressure of the left valve casing 31 is reduced or disappears, while the right valve casing 32 has a greater water pressure which pushes the balance wall 22 of the pressure regulating member 20, so that the pressure regulating member 20 is moved toward the left valve casing 31 to decrease the overlapping flow channel of one of the water guide grooves 21 of the pressure regulating member 20 and one of the annular grooves 12 of the valve tube 10 at the left valve casing 31, so as to decrease the flow rate of the cold water, and to stabilize the water temperature. Thus, the pressure regulating member 20 slides constantly in the valve tube 10 during the temperature regulating process. At this time, both of the valve tube 10 and the pressure regulating member 20 are made of ceramic material with a smooth contact face so that the outer surface of the pressure regulating member 20 is slidable smoothly in the inner surface of the valve tube 10 to enhance the balance pressure regulating precision of the ceramic balance valve structure. In addition, the surface of each of the valve tube 10 and the pressure regulating member 20 has very small pores, so that the valve tube 10 and the pressure regulating member 20 will not be easily deposited with water dirt and will not be rusted when not in use during a long period time, thereby preventing the valve tube 10 and the pressure regulating member 20 from being jammed.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A ceramic balance valve structure comprising:
a valve tube and a pressure regulating member;
wherein:
the valve tube is made of ceramic material;
the valve tube has an interior formed with a through hole which extends through the valve tube;
the valve tube has a mediate portion provided with two annular grooves connected to the through hole;
the pressure regulating member is made of ceramic material;
the pressure regulating member is slidably mounted in the through hole of the valve tube;
the pressure regulating member is provided with two water guide grooves corresponding to the annular grooves of the valve tube;
the pressure regulating member is provided with a balance wall located between the two water guide grooves;
the pressure regulating member has two opposite ends each provided with a connecting hole; and
the valve tube and the pressure regulating member have a ceramic surface contact therebetween to facilitate a sliding motion of the pressure regulating member relative to the valve tube and to prevent the pressure regulating member from being jammed in the valve tube.

2. The ceramic balance valve structure of claim 1, wherein:
the ceramic balance valve structure further comprises a balance valve housing;
the balance valve housing includes a left valve casing, a right valve casing juxtaposed to the left valve casing, and a balance valve chamber located and connected between the left valve casing and the right valve casing;
the left valve casing has a first end provided with a water inlet port and a second end provided with a water outlet port connected to the water inlet port;
the right valve casing has a first end provided with a water inlet port and a second end provided with a water outlet port connected to the water inlet port;
the balance valve chamber, the water inlet ports of the left valve casing and the right valve casing, and the water outlet ports of the left valve casing and the right valve casing are connected; and
the balance valve chamber covers the valve tube so that the pressure regulating member is slidable in the balance valve chamber.

3. The ceramic balance valve structure of claim 2, wherein:
the water inlet ports of the balance valve housing are connected to the annular grooves of the valve tube; and
the water outlet ports of the balance valve housing are connected to the connecting hole of the pressure regulating member.

4. The ceramic balance valve structure of claim 2, wherein:
the ceramic balance valve structure further comprises a valve body;
the balance valve housing is mounted in the valve body; and
each of the water outlet ports of the balance valve housing has a periphery provided with an O-ring to provide a leakproof function between the valve body and the balance valve housing.

5. The ceramic balance valve structure of claim 2, wherein the valve tube has an outer surface provided with a plurality of O-rings to provide a leakproof function between the left valve casing and the right valve casing.
